(19) United States
(12) Patent Application Publication
(10) Pub. No.: US 2008/0307840 A1
(43) Pub. Date: Dec. 18, 2008

(54) Casing and electronic device using the same

(75) Inventors: Yong-Hui Yu, Dafeng City (CN); Si-Wei Zhou, Suzhou (CN)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan (TW)

(21) Appl. No.: 12/155,034

(22) Filed: May 29, 2008

(30) Foreign Application Priority Data
Jun. 13, 2007 (TW) 96121432

(51) Int. Cl. E05B 19/00

(52) U.S. Cl. 70/393

(57) ABSTRACT

A casing and an electronic device using the same are provided. The casing is disposed at the electronic device. The casing includes a frame and a key mechanism. The frame has a first lateral plate and a second lateral plate. The first lateral plate having at least one hole and at least one hook is connected to the second lateral plate. The key mechanism has a base plate, at least one trough and at least one key. The key protrudes along an extending direction and inserts into the hole. The base plate is disposed between the second lateral plate and the hook. The hook is wedged with the trough for connecting the key mechanism and the frame.

This application claims the benefit of Taiwan application Serial No. 96121432, filed Jun. 13, 2007, the subject matter of which is incorporated herein by reference.

### BACKGROUND OF THE INVENTION

1. Field of the Invention

The invention relates in general to a casing and an electronic device using the same, and more particularly to a casing with a key and an electronic device using the same.

2. Description of the Related Art

Referring to FIG. 1, a cross-sectional view of a conventional casing is illustrated. The casing 100 includes a frame 110 and a key mechanism 120. The key mechanism 120 disposed at the frame 110 includes a key 121 and a positioning hole 124. The frame 110 has a hole 111 and a positioning column 114. The key 121 cooperates with the hole 111, and the positioning column 114 cooperates with the positioning hole 124.

When assembled, the conventional key mechanism 120 is disposed at the frame 110 along an assembling direction D1. The key 121 is inserted into the hole 111, so that a user can select a function corresponding to the key 121. The positioning column 114 is inserted into the positioning hole 124. After the positioning column 114 is melted, the key mechanism 120 is fixed at the frame 110.

However, when the key mechanism 120 is assembled along the assembling direction D1, the key 121 usually contacts the lateral plate 150. As a result, the key 121 tends to deform and the position of the key 121 is usually away from the hole 111. Sometimes, the key mechanism 120 may even be broken. As the positioning column 114 is melted at this time to fix the key mechanism 120 and the frame 110, the key mechanism 120 can not be replaced alone. In other words, the key mechanism 120 and the frame 110 have to be replaced together.

### SUMMARY OF THE INVENTION

The invention is directed to a casing and an electronic device using the same. A hook and a trough cooperate together to fix a key mechanism at a frame.

According to a first aspect of the present invention, a casing is provided. The casing is disposed at an electronic device. The casing includes a frame and a key mechanism. The frame has a first lateral plate and a second lateral plate. The first lateral plate having at least one hole and at least one hook is connected to the second lateral plate. The key mechanism has a base plate, at least one trough and at least one key. The key protrudes along an extending direction and inserts into the hole. The base plate is disposed between the second lateral plate and the hook. The hook is wedged with the trough for connecting the key mechanism and the frame.

According to a second aspect of the present invention, an electronic device is provided. The electronic device includes a casing and a display element. The casing includes a frame and a key mechanism. The frame has a first lateral plate and a second lateral plate. The first lateral plate having at least one hole and at least one hook is connected to the second lateral plate. The key mechanism has a base plate, at least one trough and at least one key. The key protrudes along an extending direction and inserts into the hole. The base plate is disposed between the second lateral plate and the hook. The hook is wedged with the trough for connecting the key mechanism and the frame. The display element is disposed in the casing.

The invention will become apparent from the following detailed description of the preferred but non-limiting embodiments. The following description is made with reference to the accompanying drawings.

### BRIEF DESCRIPTION OF THE DRAWINGS

FIG. 1 illustrates a cross-sectional view of a conventional casing;

FIG. 2 illustrates an electronic device according to a first embodiment of the present invention;

FIG. 3A illustrates a part of the casing in FIG. 2;

FIG. 3B illustrates a cross-sectional view of the casing in FIG. 3A;

FIG. 4 illustrates a part of the casing according to a second embodiment of the present invention; and

FIG. 5 illustrates a cross-sectional view of the frame in FIG. 4

### DETAILED DESCRIPTION OF THE INVENTION

### First Embodiment

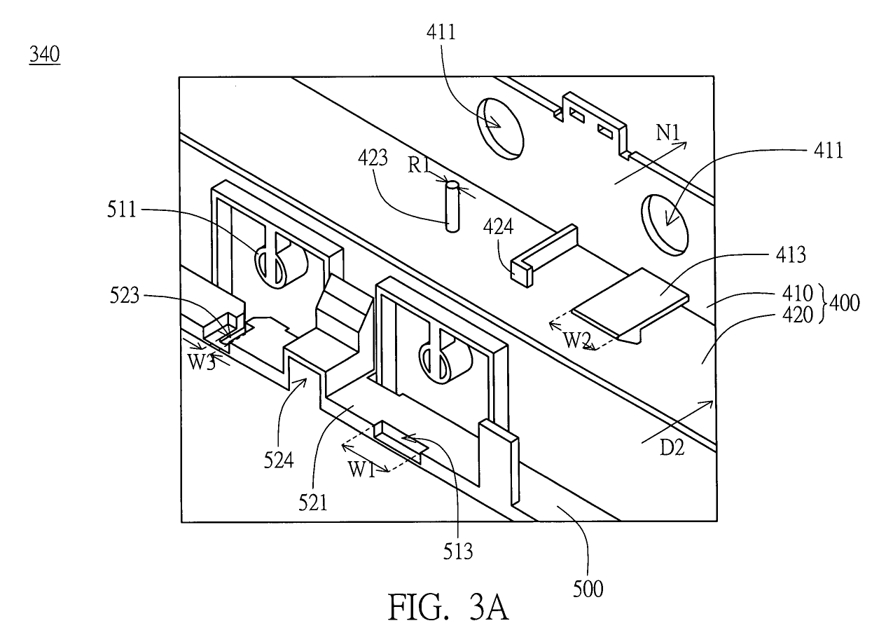

Referring to FIG. 2, an electronic device according to a first embodiment of the present invention is illustrated. The electronic device is, for example, a display device 300 in the present embodiment. The display device 300 includes a casing 340 and a display element 320. The display element 320 is disposed in the casing 340. Although the display device 300 is taken to be an example herein, the invention is not limited thereto.

The casing 340 includes a frame 400 and a key mechanism 500. The key mechanism 500 is disposed at the frame 400. The frame 400 has a first lateral plate 410 and a second lateral plate 420. The first lateral plate 410 is connected to the second lateral plate 420. The first lateral plate 410 is, for example, substantially perpendicular to the second lateral plate 420.

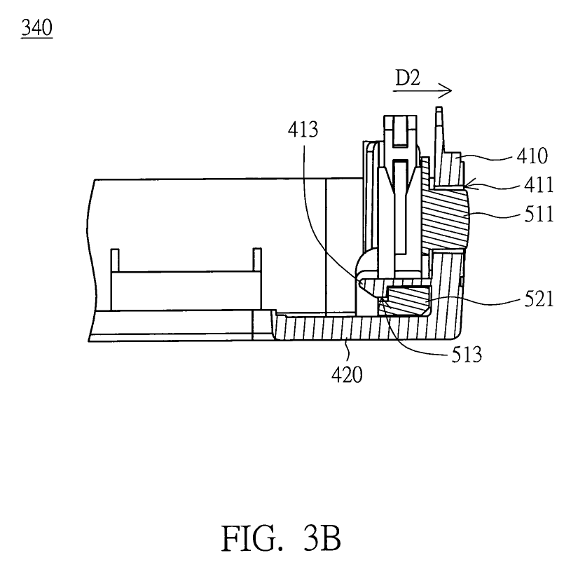

Referring to both FIG. 3A and FIG. 3B, FIG. 3A illustrates a part of the casing in FIG. 2, and FIG. 3B illustrates a cross-sectional view of the casing in FIG. 3A. The first lateral plate 410 has several holes 411 and several hooks 413. The key mechanism 500 has a base plate 521, several troughs 513 and several keys 511. As only a part of the casing 340 is illustrated in FIG. 3A and FIG. 3B, only one hook 413 and one trough 513 are shown.

As shown in FIG. 3A and FIG. 3B, the keys 511 protrude along an extending direction D2 and insert into the holes 411. The base plate 521 is disposed between the second lateral plate 420 and the hook 413. The hook 413 is wedged with the trough 513 for connecting the key mechanism 500 and the frame 400.

The width W2 of the hook 413 is substantially equal to the width W1 of the trough 513, and the number of the hooks 413 corresponds to the number of the troughs 513, so that the key mechanism 500 is positioned at the frame 400 by the cooperation of the hooks 413 and the troughs 513. Furthermore, the number of the keys 511 also corresponds to the number of the holes 411. Although the present embodiment has several holes 411, keys 511, hooks 413 and troughs 513, the present invention is not limited thereto. The present invention encompasses such modification as long as the number of the components cooperating together corresponds to each other.

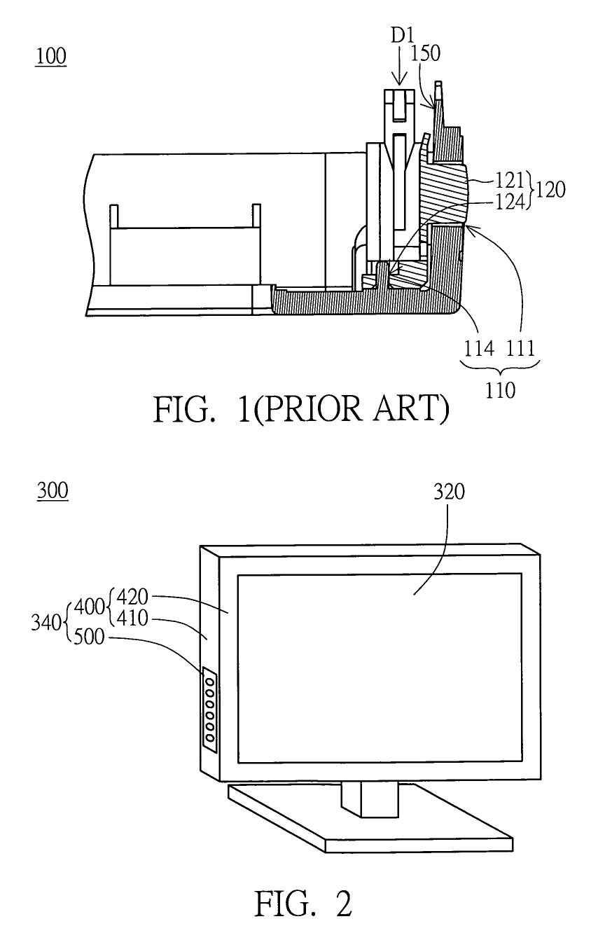

When the hook 413 and the trough 513 are wedged with each other, the key mechanism 500 is positioned at the frame 400. As a result, the condition that the key 121 (as shown in FIG. 1) is deformed due to contacting with the lateral plate 150 (as shown in FIG. 1) can be avoided.

As shown in FIG. 3A, the key mechanism 500 has at least one long opening 523, and the second lateral plate 420 has at least one positioning column 423 and at least one positioning block 424. The location and the number of the long opening 523 correspond to those of the positioning column 423. When the key mechanism 500 is disposed along the extending direction D2, the positioning column 423 slides into the long opening 523 easily so as to increase the disposition accuracy of the key mechanism 500.

As the key mechanism 500 is assembled along the extending direction D2, that is, a normal direction N1 of the first lateral plate 410, the keys 511 would not contact with the first lateral plate 410. Therefore, the keys 511 would not deform, and be away from the holes 411, and the key mechanism 500 would not be damaged.

In addition, the width W3 of the long opening 523 is slightly larger than the diameter R1 of the positioning column 423, so that the positioning column 423 slides into the long opening 523 easily. The positioning block 424 cooperates with an edge 524 of the base plate 521 for further positioning the key mechanism 500 at the frame 400. Although the present embodiment includes only one long opening 523 and one positioning column 423, the invention is not limited thereto. The casing 340 can include several long openings and positioning columns, as long as the number of the long openings and the positioning columns corresponds to each other.

Although the long opening 523, the positioning column 423 and the positioning block 424 are disposed at the casing 340, the invention is not limited thereto. These components can be selectively disposed at the casing.

### Second Embodiment

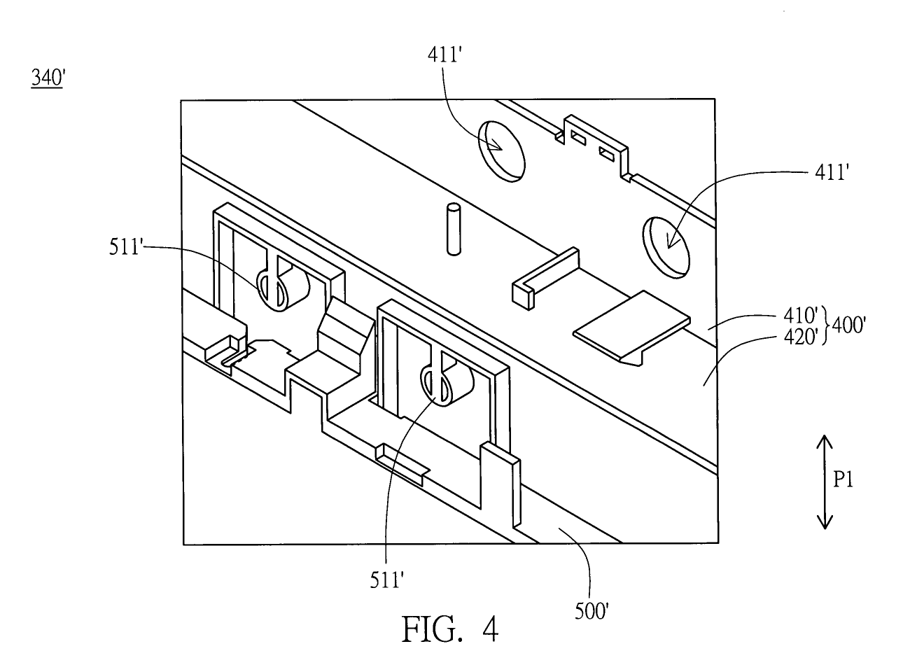

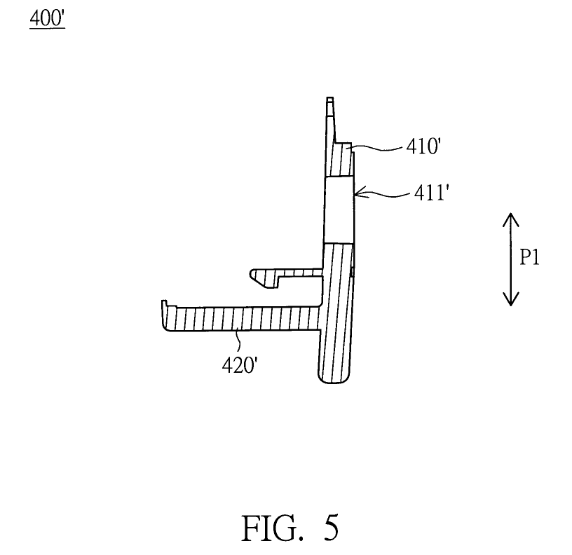

The difference between the present embodiment and the first embodiment is in the design of the second lateral plate. Referring to FIG. 4 and FIG. 5, FIG. 4 illustrates a part of the casing according to a second embodiment of the present invention, and FIG. 5 illustrates a cross-sectional view of the frame in FIG. 4. The same as the first embodiment, the casing 340′ of the present embodiment includes the frame 400′ and the key mechanism 500′. However, the second lateral plate 420′ of the frame 400′ is a protruding rib on the first lateral plate 410′.

When the holes 411′ of the first lateral plate 410′ need to be disposed at a specific height, the position of the second lateral plate 420′ can be adjusted along the vertical direction P1. The height of the key mechanism 500′ disposed on the frame 400′ can be adjusted accordingly. As a result, the height of the keys 511′ of the key mechanism 500′ corresponds to the height of the holes 411′. In other words, even the holes 411′ are located at a different height, the height of the keys 511′ of the key mechanism 500′ can be adjusted through the disposition of the second lateral plate 420′ for cooperating with the holes 411′.

The casing and the electronic device using the same disclosed in the above embodiment of the invention are for positioning the frame and the key mechanism of the casing. The hook of the frame cooperates with the trough of the key mechanism, so that the key mechanism is positioned at the frame. Furthermore, the key mechanism is assembled along the normal direction of the first lateral plate, so that the keys do not contact with the first lateral plate. Therefore, the keys would not deform and is away from the holes, so the key mechanism is not damaged. Moreover, the positioning block and the base plate cooperating together are also able to position the key mechanism at the frame stably.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A casing disposed at an electronic device, comprising:
a frame having a first lateral plate and a second lateral plate, wherein the first lateral plate is connected to the second lateral plate, and the first lateral plate has at least one hole and at least one hook; and
a key mechanism having a base plate, at least one trough and at least one key, wherein the key protrudes along an extending direction and inserts into the hole, the base plate is disposed between the second lateral plate and the hook, and the hook is wedged with the trough for connecting the key mechanism and the frame.

2. The casing according to claim 1, wherein the key mechanism has at least one long opening, the second lateral plate has at least one positioning column, and the long opening is substantially parallel to the extending direction for cooperating with the positioning column.

3. The casing according to claim 2, wherein the long opening is substantially parallel to a normal direction of the first lateral plate.

4. The casing according to claim 2, wherein the key mechanism has a plurality of long openings, the second lateral plate has a plurality of positioning columns, and the number of the long openings corresponds to the number of the positioning columns.

5. The casing according to claim 2, wherein the width of the long opening is slightly larger than the diameter of the positioning column.

6. The casing according to claim 1, wherein the first lateral plate and the second lateral plate are substantially perpendicular to each other.

7. The casing according to claim 1, wherein the second lateral plate is a protruding rib.

8. The casing according to claim 1, wherein the width of the hook is substantially equal to the width of the trough.

9. The casing according to claim 1, wherein the key mechanism has a plurality of keys, the first lateral plate has a plurality of holes, and the number of the keys corresponds to the number of the holes.

10. The casing according to claim 1, wherein the second lateral plate has at least one positioning block, and the positioning block is used for cooperating with an edge of the base plate to position the key mechanism.

11. An electronic device comprising:
a casing comprising:
a frame having a first lateral plate and a second lateral plate, wherein the first lateral plate is connected to the second lateral plate, and the first lateral plate has at least one hole and at least one hook; and
a key mechanism having a base plate, at least one trough and at least one key, wherein the key protrudes along an extending direction and inserts into the hole, the base plate is disposed between the second lateral plate and the hook, and the hook is wedged with the trough for connecting the key mechanism and the frame; and
a display element disposed in the casing.

12. The electronic device according to claim 11, wherein the key mechanism has at least one long opening, the second lateral plate has at least one positioning column, and the long opening is substantially parallel to the extending direction for cooperating with the positioning column.

13. The electronic device according to claim 12, wherein the long opening is substantially parallel to a normal direction of the first lateral plate.

14. The electronic device according to claim 12, wherein the key mechanism has a plurality of long openings, the second lateral plate has a plurality of positioning columns, and the number of the long openings corresponds to the number of the positioning columns.

15. The electronic device according to claim 12, wherein the width of the long opening is slightly larger than the diameter of the positioning column.

16. The electronic device according to claim 11, wherein the first lateral plate and the second lateral plate are substantially perpendicular to each other.

17. The electronic device according to claim 11, wherein the second lateral plate is a protruding rib.

18. The electronic device according to claim 11, wherein the width of the hook is substantially equal to the width of the trough.

19. The electronic device according to claim 11, wherein the key mechanism has a plurality of keys, the first lateral plate has a plurality of holes, and the number of the keys corresponds to the number of the holes.

20. The electronic device according to claim 11, wherein the second lateral plate comprises at least a positioning block for cooperating with an edge of the base plate to position the key mechanism.
